(19) United States
(12) Patent Application Publication
(10) Pub. No.: US 2002/0022965 A1
(43) Pub. Date: Feb. 21, 2002

(54) System and method for generating accounting data and computer-readable recording medium recorded with program for causing computer to generate accounting data

(75) Inventor: Hideumi Egawa, Tokyo (JP)

Correspondence Address: David A. Blumenthal, FOLEY & LARDNER, Washinton Harbour, 3000 K Street, N.W., Suite 500, Washington, DC, 20007-5109, US

(73) Assignee: NEC CORPORATION

(21) Appl. No.: 09/837,328

(22) Filed: Apr. 19, 2001

(30) Foreign Application Priority Data
Apr. 19, 2000 (JP) 2000-118696

(51) Int. Cl. G06F 17/60

(52) U.S. Cl. 705/1

(57) ABSTRACT

In a system for generating household account data, expense information, which includes purchasing instrument information obtained by a settlement process of a business transaction using a purchasing instrument capable for payment, is collected and household account data is generated for a user of the purchasing instrument or a household account summary of a household of the user.

### BACKGROUND OF THE INVENTION

1. Field of the Invention

The present invention generally relates to a system and a method for generating accounting data and a computer-readable recording medium recorded with program for causing computer to generate accounting data, more particularly to a system for automatically generating household accounting data, a method for automatically generating household accounting data and a computer-readable recording medium recorded with a program for causing a computer to generate the household accounting data.

The present application claims priority of Japanese Patent Application No. 2000-118696 filed on Apr. 19, 2000, which is hereby incorporated by reference.

2. Description of the Related Art

Conventionally, in order to generate household account data, an operation for re-writing necessary items is periodically repeated. That is, for income items in a household account book, necessary items are written based on salary details, and deposit information and transfer information recorded in a bankbook issued by a banking institution. Also, for expense items in the household account book, the necessary items are written based on receipts or other expenses.

By using household account generating software, the household account is generated. In this case, it is required to manually input data, Thus, a relatively large amount of time and workload is needed for the household account to be precise. Also, it is required to pay careful attention to maintain receipts of purchases and receipts of sales.

Recently, it is realized that the household account data is electrically generated. For example, Japanese Laid-open Hei 9-293096 disclosed that when a consumer purchases products at retail shops, transaction information including product names, quantities, prices, and like of the products is transmitted from retail shops to a banking institution managing an account of the consumer, which is to be charged. In the banking institution, a predetermined process is conducted for the transaction information and then processed transaction information is electrically sent to a home of the consumer. It can be realized for the consumer to electrically generate household account data based on received transaction information

However, in the conventional technology described above, in a case in which the household account data is generated by using information of a settlement process as the expense information of the purchased products, for example, a relative longer time lag can be occurred between a date when the consumer purchased the products and another date when the retail shops charged to the account of the consumer. Thus, discrepancies and errors can be caused in records of the household account.

### SUMMARY OF THE INVENTION

In view of the above, it is an object of the present invention to provide a system and a method for automatically generating accounting data and a computer-readable recording medium recorded with a program for causing a computer to generate accounting data in which the above-mentioned problems are eliminated.

Also, it is another object of the present invention to provide a system and a method for automatically generating household account data and a computer-readable recording medium recorded with a program for causing a computer to generate household account data which can reduce problems of inputting data and maintaining receipts and also can easily generate precise and reliable household account data.

According to a first aspect of the present invention, there is provided a system for generating accounting data, including:

an information collecting means for collecting expense information including purchasing instrument information obtained by a settlement process of a business transaction using a purchasing instrument capable for payment; and

a data generating means for generating accounting data of a user of the purchasing instrument or a accounting summary of a household of the user.

In the foregoing first aspect, a preferable mode is one wherein the purchasing instrument is a debit card issued by a banking institution.

Also, a preferable mode is one wherein the expense information includes account information of a banking institution where the user or the household has an account; and

the data generating means conducts a calculating process and an editing process to the expense information and generates the accounting data.

Also, a preferable mode is one that wherein further includes a sending means for sending the accounting data to a predetermined receiving terminal through a communication line.

Also, a preferable mode is one wherein the information collecting means is provided in the banking institution and receives the expense information from a computer accumulating the expense information through a communication line.

Also, a preferable mode is one wherein the information collecting means collects income information and the data generating means generates the accounting data of the user or the household account summary of the household of the user based on the expense information and the income information.

Also, a preferable mode is one that wherein further includes a household account book data generating means for generating a household account book data based on the accounting data generated by the data generating means wherein the sending means sends the household account book data to a predetermined facsimile through the communication line.

Also, a preferable mode is one wherein the information collecting means is provided in the banking institution and receives the expense information from a computer accumulating the expense information through a communication line.

Also, a preferable mode is one wherein the receiving terminal generates a accounting book data based on the accounting data received from the communication line.

Also, a preferable mode is one wherein the communication line includes Internet.

Also, a preferable mode is one wherein the receiving terminal is an information processing apparatus provided in the household of the user.

Also, a preferable mode is one wherein the receiving terminal is an output terminal provided in the banking institution or an automated transaction apparatus including a receiving function for receiving the accounting data.

According to a second aspect of the present invention, there is provided a method for generating accounting data, including steps of:

(a) step for collecting expense information including purchasing instrument information obtained by a settlement process of a business transaction using a purchasing instrument capable for payment; and

(b) step for generating accounting data of a user of the purchasing instrument or a accounting summary of a household of the user.

In the foregoing second aspect, a preferable mode is one wherein:

the expense information includes account information of a banking institution where the user or the household has an account; and

the step (b) conducts a calculating process and an editing process to the expense information and generates the accounting data.

According to a third aspect of the present invention, there is provided a computer-readable recording medium recorded with a program for causing a computer to generate accounting data, including codes of:

(a) code for collecting expense information including purchasing instrument information obtained by a settlement process of a business transaction using a purchasing instrument capable for payment; and

(b) code for generating accounting data of a user of the purchasing instrument or a accounting summary of a household of the user.

In the foregoing second aspect, a preferable mode is one wherein:

the expense information includes account information of a banking institution where the user or the household has an account; and

the code (b) conducts a calculating process and an editing process to the expense information and generates the accounting data.

With the above configurations, it is possible to reduce problems of inputting data and maintaining receipts, and also it is possible to easily and precisely generate a household account book.

Also, for example, the debit card transaction information, which is a result of the immediate settlement by use of the debit card, is used as the expense information when a product is purchased. Therefore, it is possible to generate a precise and reliable household account book without a time lag.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a configuration of a household account generating system according to a first embodiment of the present invention;

FIG. 2A is a block diagram showing a configuration of a household account data generating program stored in a program storing unit according to the first embodiment of the present invention and FIG. 2B is a block diagram showing a configuration of an information storing unit of a household account data generating apparatus configured in the household account generating system according to the first embodiment of the present invention;

FIG. 3 is a diagram showing transaction detail data stored in a transaction detail data storing area of the information storing unit according to the first embodiment of the present invention;

FIG. 4 is a diagram showing calculated data stored in a calculated data storing area of the information storing unit according to the first embodiment of the present invention;

FIG. 5 is a diagram showing a household account book output from a printing unit of an information processing apparatus configured in the household account generating system according to the first embodiment of the present invention;

FIG. 6 is a flowchart for explaining operations of the household account data generating apparatus according to the first embodiment of the present invention;

FIG. 7 is a block diagram showing a configuration of a household account generating system according to a second embodiment of the present invention; and

FIG. 8 is a block diagram showing a configuration of a household account generating system according to a third embodiment of the present invention.

### DESCRIPTION OF THE PREFERRED EMBODIMENTS

Best modes for carrying out the present invention will be described in further detail using an embodiment with reference to the accompanying drawings.

First Embodiment

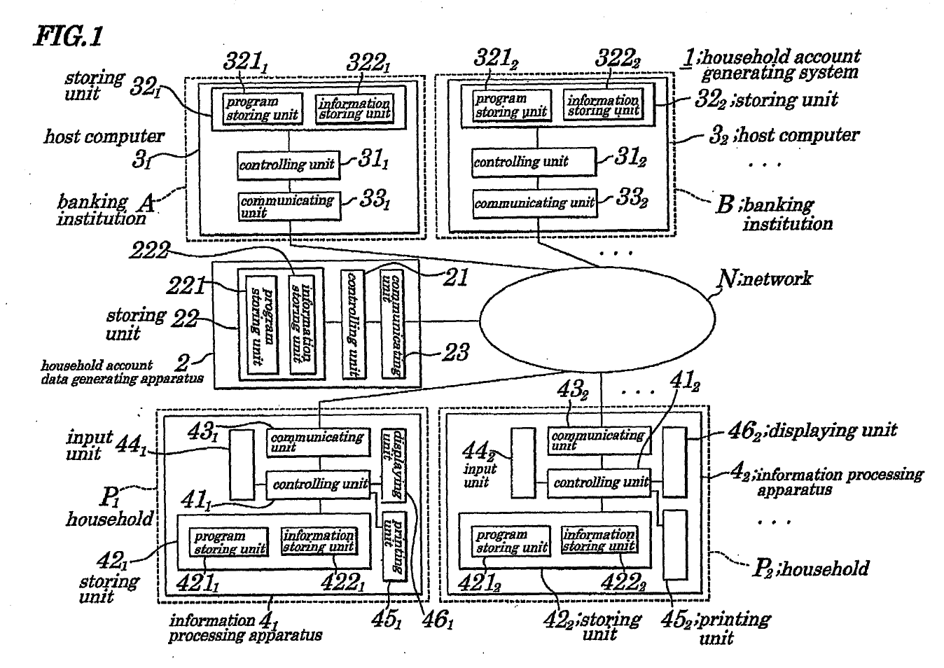

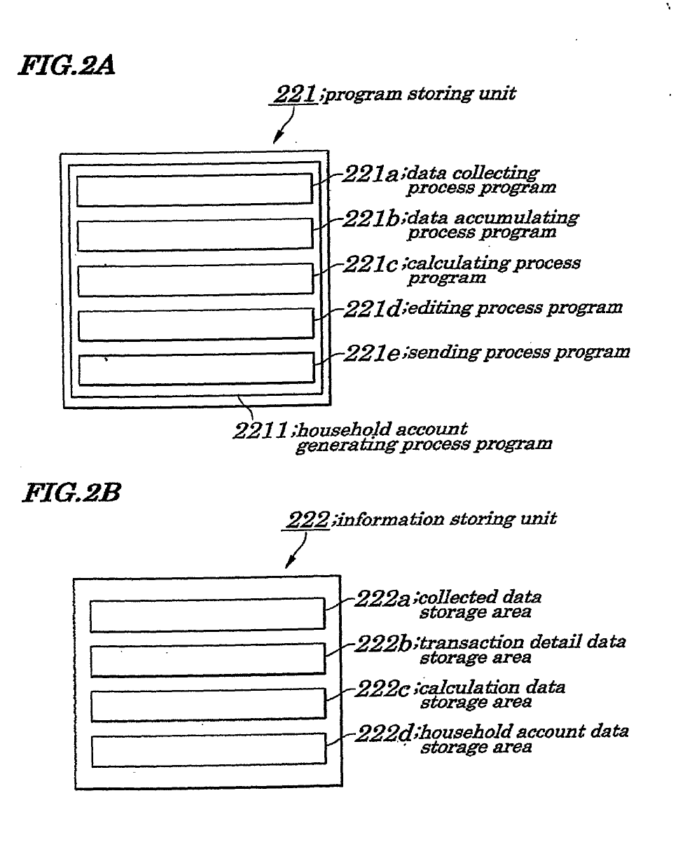

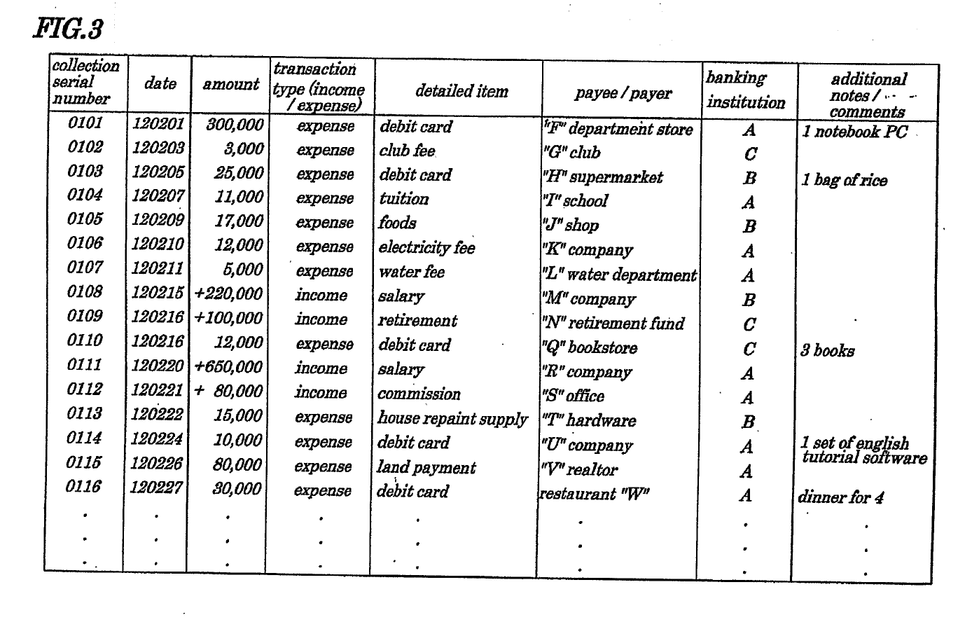

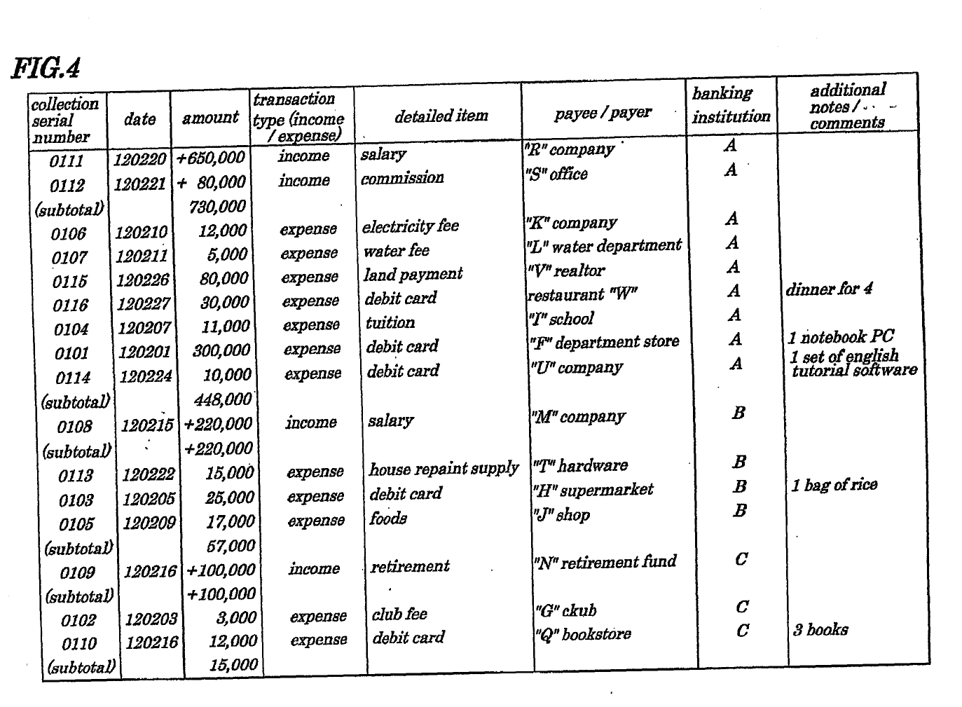

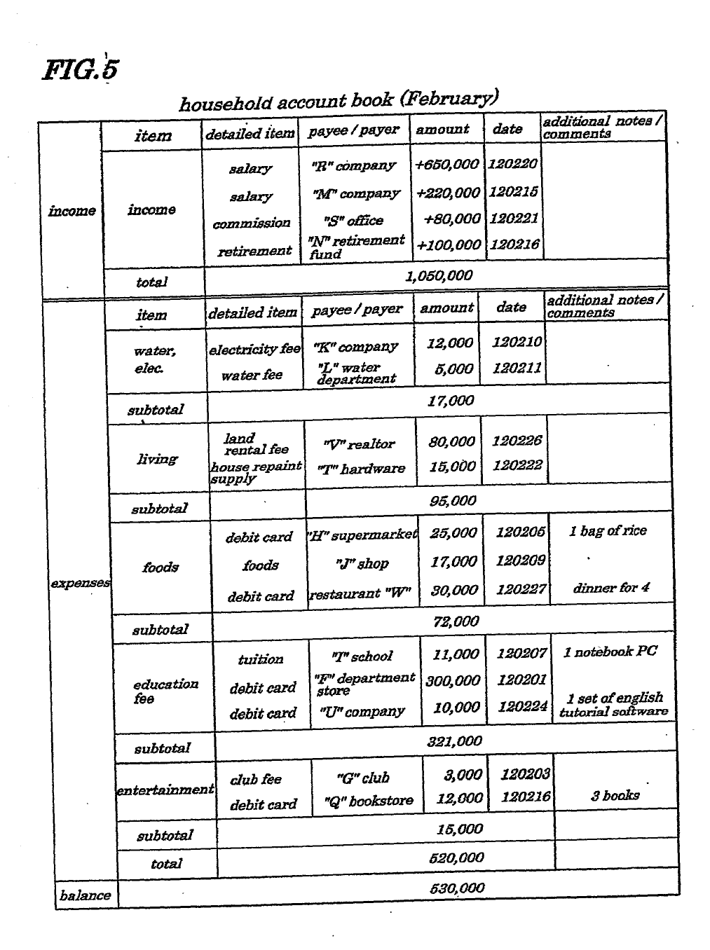

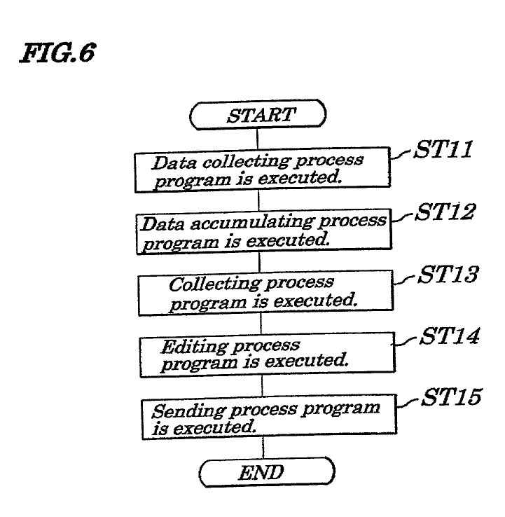

FIG. 1 is a block diagram showing a configuration of a household account generating system according to a first embodiment of the present invention. FIG. 2A is a block diagram showing a configuration of a household account data generating program stored in a program storing unit and FIG. 2B is a block diagram showing a configuration of an information storing unit of a household account data generating apparatus configured in the household account generating system. FIG. 3 is a diagram showing transaction detail data stored in a transaction detail data storing area of the information storing unit. FIG. 4 is a diagram showing calculated data stored in a calculated data storing area of the information storing unit. FIG. 5 is a diagram showing the household account book output from a printing unit of the information processing apparatus configured in the household account generating system. And, FIG. 6 is a flowchart for explaining operations of the household account data generating apparatus.

As shown in FIG. 1, the household account generating system 1 (corresponding to a system for generating a household account in claims) includes, for example, a household account data generating apparatus 2 for obtaining transaction data for each household and automatically generating the household account data, host computers 3₁, 3₂, . . . , which are individually provided to banking institutions A, B, . . . including banks, for providing transaction data such as account information, debit card transaction information, and a like to the household account generating apparatus 2 through a network N such as the Internet in response to a request, and information processing apparatuses 4₁, 4₂, . . . (corresponding to a receiving terminal in claims) provided in households P₁, P₂, . . . for receiving the household account data from the household account data generating apparatus 2 through the network N and then generating household account book.

The household account data generating apparatus 2 includes a controlling unit 21 for controlling each unit in accordance with a predetermined control program, a storing unit 22 for storing various programs or data or a like, and a communicating unit 23 for conducting data communication in accordance with a predetermined protocol to any one of the host computers 3₁, 3₂, . . . or any one of the information processing apparatuses 4₁, 4₂, . . .

The controlling unit 21 executes a household account generating process program recorded in a program storing unit 221 (that will be described later) of the storing unit 22. That is, the controlling unit 21 controls each unit of the household account data generating apparatus 2 by using various registers and flags provided in the storing unit 22 so as to generate household account data.

The storing unit 22 includes a ROM (Read Only Memory) (not shown), a RAM (Random Access Memory) (not shown), and a hard disk storage device (not shown). Also, the storing unit 22 may include a semiconductor memory such as an IC memory card or a like, a floppy disk storage device, or a magneto-optical disc storage device. In addition, the storing unit 22 includes the program storing unit 221 for-storing various process programs including a household account data generating process program 2211 conducted by the controlling unit 21, and an information storing unit 222 for storing information including transaction data necessary to generate the household account data obtained from any one of the host computers 3₁, 3₂, . . . through the communicating unit 23. The household account data generating process program 2211 stored in a program storing unit 221 includes a data collecting process program 221a for periodically collecting transaction data such as general account information, debit card transaction information or a like from the host computers 3₁, 3₂, . . . through the communicating unit 23 and then temporarily storing the transaction data; a data accumulating process program 221b for additionally providing management information (collection date, collection serial number and a like) to each detailed statement of the transaction data, for example, generating transaction detail data as shown in FIG. 3, and then storing the transaction detail data; a calculating process program 221c for calculating the transaction detail data, for example, for each account, obtaining calculation data as shown in FIG. 4, and then storing the calculation data; an editing process program 221d for conducting an editing process to the calculation data so as to create the household account data adjusted in a predetermined form for a specific period specified by user and then storing the household account data; and a sending process program 221e for sending the household account data to the information processing apparatuses 4₁, 4₂, . . . through the communicating unit 23.

Also, the information storing unit 222 includes a collected data storage area 222a for temporarily storing the transaction data obtained through the communicating unit 23, a transaction detail data storage area 222b for storing the transaction detail data, a calculation data storage area 222c for storing calculated data, and a household account data storage area 222d for storing the household account data.

The host computers 3₁, 3₂, . . . include controlling units 31₁, 31₂, . . . for controlling each unit in accordance with a predetermined control program, storing units 32₁, 32₂, . . . for storing various programs and data, communicating unit 33₁, 33₂, . . . for communicating with the household account data generating apparatus 2 in accordance with a predetermined protocol.

The controlling units 31₁, 31₂, . . . execute a transaction data sending program or a like loaded in program storing units 321₁, 321₂, . . . (that will be described later) of the storing units 32₁, 32₂, . . . , controls each unit of the host computer 3₁, 3₂, . . . by using various registers and flags in the storing units 32₁, 32₂, . . . , and then, for example, provides the transaction data to the household account data generating apparatus 2.

Each of the storing units 32₁, 32₂, . . . includes a ROM (Read Only Memory) (not shown), a RAM (Random Access Memory) (not shown), and a hard disk storage device (not shown). Also, each of the storing units 32₁, 32₂, . . . may include a semiconductor memory such as an IC memory card or a like, a floppy disk storage device, or a magneto-optical disc storage device. In addition, the storing units 32₁, 32₂, . . . include the program storing unit 321₁, 321₂, . . . for storing various process programs including the transaction data sending program conducted by the controlling units 31₁, 31₂, . . . , and information storing units 322₁ 322₂, . . . for accumulating account information, the transaction data including debit card transaction data for each of households P₁, P₂, . . . Also, the storing units 32₁, 32₂, . . . include various registers and flags used by the controlling units 31₁, 31₂, . . . executing the programs.

It should be noted that the account information includes income information such as salary income information, expense information such as public or private utility charge information, or a like.

For example, a member of the household P, purchases a product at a shop using a purchasing instrument as a debit card issued by the banking institution A, or B, or . . . in which the member is an account holder. Then, an amount of money for the product is immediately charged from a deposit account after a bank balance of the deposit account of the banking institution A, or B, or . . . is checked. The debit card transaction information includes expense information as a result of an immediate settlement process.

The information processing apparatuses 4₁, 4₂, . . . are, for example, personal computers. The information processing apparatuses 4₁, 42₂, . . . include controlling unit 41₁, 41₂, . . . for controlling each unit in accordance with a predetermined control program, storing units 42₁, 42₂, . . . for storing various programs and data, communicating units 43₁, 43₂, . . . for conducting data communications with the household account data generating apparatus 2 in accordance with a predetermined protocol, input units 44₁, 44₂, . . . for inputting necessary data, printing units 45₁, 45₂, . . . for printing generated household account book, and displaying units 46₁, 46₂, . . . for displaying the household account book.

The controlling unit 41₁, 41₂, . . . execute the household account generating program or the like stored in program storing units 421₁, 421₂, . . . (that will be described later), control each unit of the information processing apparatuses 4₁, 4₂, . . . by using various registers and flags provided in the storing units 42₁, 42₂, . . . , and then, for example, generating a household account book for a specific period specified by the user.

Each of the storing units 42₁, 42₂, . . . includes a ROM (Read Only Memory) (not shown), a RAM (Random Access Memory) (not shown), and a hard disk storage device (not shown). Also, each of the storing units 42₁, 42₂, . . . may include a semiconductor memory such as an IC memory card or a like, a floppy disk storage device, or a magneto-optical disc storage device. In addition, the storing units 42₁, 42₂, . . . include the program storing unit 421₁, 421₂, . . . for storing various process programs including the transaction data sending program and the household account generating program conducted by the controlling units 41₁, 41₂, . . . , and information storing units 422₁ 422₂, . . . for storing received household account data or processed household account data. Also, the storing units 42₁, 42₂, . . . include various registers and flags used by the controlling units 41₁, 41₂, . . . executing the programs.

The household account generating program conducts a predetermined process to the received household account data and then generates the household account book. For example, the household account generating program further can display a graph diagram.

Each of the input units 44₁, 44₂, . . . includes a keyboard, a pointing device such as a mouse, or a like.

Each of the printing units 45₁, 45₂, . . . prints out, for example, a household account data as shown in FIG. 5.

Each of the displaying units 46₁, 46₂, . . . includes a CRT (Cathode Ray Tube) display, an LCD (Liquid Crystal Display), a plasma display, or a like.

A household account generating method using the household account generating system 1 will now be described with reference to FIG. 6.

An example in FIG. 6 shows a settlement process for a case in which a plurality of member of the household P₁ open accounts of the banking institutions A, B, . . . and they purchase products by debit cards issued by the banking institutions A, B, . . .

First, in step ST11, the controlling unit 21 of the household account data executes the data collecting process program 221a.

The controlling unit 21 collects the transaction data including the general account information and the debit card transaction information, and temporarily stores the transaction information to the collected data storage area 222a. The transaction data includes a transaction amount of money, a detail item, a description of transaction, and a like.

For example, in a case in which a member of the household P₁ has a deposit account (hereinafter, may also be called an account) of the banking institution A, when salary is electronically transferred to the account of the member, the information storing unit 322₁ of the host computer 3₁ provided in the banking institution A stores that transaction as income information. When an electricity bill is drawn from the account of the member, the information storing unit 322₁ stores that transaction as expense information. Then, the income information and the expense information are collected.

Also, when the member or another household member purchases a product at a shop with a debit card issued by the banking institution A, a transaction amount of money is immediately drawn after the banking institution A checks a bank balance of the account. The information storing unit 322₁ stores and collects the transaction as the expense information.

Subsequently, the data accumulating process program 221b is executed (step ST12). As shown in FIG. 3, the controlling unit 21 additionally provides management information (collection date and collection serial number) to each transaction detail of the collected transaction data and then creates transaction detail data. The transaction detail data is accumulated in the transaction detail data storage area 222b.

Next, the collecting process program is executed (step ST13). The controlling unit 21 calculates a total of the transaction detail data for each account as shown in FIG. 4 so as to obtain calculation data. The calculation data is stored in the calculation data storage area 222c. For example, the calculation data may be categorized by item or date.

Next, the editing process program is executed (step ST14). The controlling unit 21 conducts the editing process to the calculation data so as to create the household account data adjusted in the predetermined form for a specific period specified by the user. The household account data is stored in the household account data storage area 222d.

Next, the sending process program is executed (step ST15). The controlling unit 21 sends the household account data to the information processing apparatus 4, through the communicating unit 23.

After that, in the information processing apparatus 4₁, the controlling unit 41₁ receives the household account data through the communicating unit 43₁ and executes the household account generating program to create the household account for a specific period specified by the user (for example, one month) for each account of each of the banking institutions A, B, . . . based on the received household account data. Moreover, as shown in FIG. 5, the household account generating program synthesizes contents for each account and generates the household account book including data from any of the bank institutions A, B, . . . Furthermore, for example, the household account generating program may generate a pie chart showing a breakdown of income sources or a breakdown of expenses or a line graph showing a sequential change of a total amount of money for each item in order to compare with data of previous months, and prints out the pie chart or the line graph on the printing unit 45₁.

The household account data generating apparatus 2 simultaneously sends the transaction data to other households P₂, P₃, . . . in the same manner.

According to the first embodiment, the household account data generating apparatus 2 collects the transaction data, automatically creates the household account data, and the sends the information processing apparatus 4₁, 4₂, . . . of the household P₁, P₂, . . . Therefore, it is possible to eliminate an operation of data input and to reduce problems of maintaining receipts. In addition, it is possible to easily and precisely generate a household account book. Consequently, in each household P₁, P₂, . . . , it is possible to obtain the household account book precisely describing specific items without any special operation.

Also, for example, as the expense information of purchased products, the debit card transaction information, which is a result of the immediate settlement for use of debit card, is used. Thus, it is possible to generate the household account book that is precise and reliable much more than information of a settlement process for payments when a credit card is used and there is no time lag.

Second Embodiment

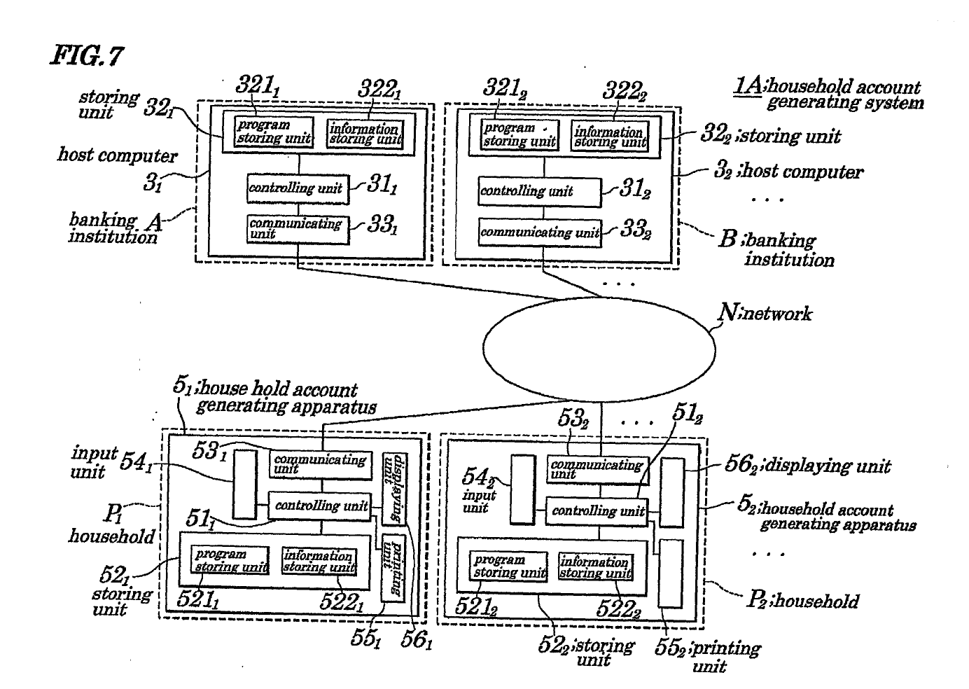

FIG. 7 is a block diagram showing a configuration of a household account generating system 1A according to a second embodiment of the present invention.

As shown in FIG. 7, a different point from the first embodiment is that household account generating apparatuses 5₁, 5₂, . . . are provided households P₁, P₂, . . . , respectively, and a household account book is output to each household.

The configurations of the second embodiment other than the point described above are the same as the configuration of the first embodiment and the explanation thereof will be omitted.

As shown in FIG. 7, for example, the household account generating system 1A (corresponding to a system for generating a household account in claims) includes the household account generating apparatuses 5₁, 5₂, . . . , which are provided for households P₁, P₂, . . . , respectively, for obtaining transaction data for each of the households P₁, P₂, . . . and then automatically generating the household account book, and host computers 3₁, 3₂, . . . , which are provided in banking institutions A, B, . . . , for providing the transaction data including account information, debit card transaction information or a like to the household accounts generating apparatuses 5₁, 5₂, . . . through a network N such as the Internet in response to a request.

For example, the household account generating apparatuses 5₁, 5₂, . . . are personal computers and include controlling units 51₁, 51₂, . . . for controlling each unit in accordance with a predetermined control program, storing units 52₁, 52₂, . . . for storing various programs and data, communicating units 53₁, 53₂, . . . for communicating with the host computers 3₁, 3₂, . . . in accordance with a predetermined protocol, input units 54₁, 54₂, . . . for inputting necessary data, printing units 55₁, 55₂, . . . for printing the generated household account book, and displaying units 56₁, 56₂, . . . for displaying the household account book.

The controlling units 51₁, 51₂, . . . execute the household account generating program 2211 or the like stored in program storing units 521₁, 521₂, . . . (that will be described later), control each unit of the household account generating apparatuses 5₁, 5₂, . . . by using various registers and flags provided in the storing units 52₁, 52₂, . . . , and then generating the household account book.

Each of the storing units 52₁, 52₂, . . . includes a ROM (Read Only Memory) (not shown), a RAM (Random Access Memory) (not shown), and a hard disk storage device (not shown). Also, each of the storing units 52₁, 52₂, . . . may include a semiconductor memory such as an IC memory card or a like, a floppy disk storage device, or a magneto-optical disc storage device. In addition, the storing units 52₁, 52₂, . . . include the program storing units 521₁, 521₂, . . . for storing various process programs including a household account generating program 2211 conducted by the controlling units 51₁, 51₂, . . . , and information storing units 522₁, 522₂, . . . for storing received household account data or processed household account data. Also, the storing units 52₁, 52₂, . . . include various registers and flags used by the controlling units 51₁, 51₂, . . . executing the programs.

The household account generating program 2211 stored in each of the program storing units 521₁, 521₂, . . . includes a data collecting process program 221a for periodically collecting transaction data such as general account information, debit card transaction information or a like from the host computers 3₁, 3₂, . . . through a respective one of communicating units 53₁, 53₂, . . . and then temporarily storing the transaction data; a data accumulating process program 221b for generating transaction detail data and then storing the transaction detail data; a calculating process program 221c for calculating the transaction detail data and then storing the calculation data; and an editing process program 221d for conducting an editing process of the calculation data to adjust in a predetermined form, further, for example, displaying a graph, creating household account data for a specific period specified by the user and then storing the household account data.

Also, the information storing units 522₁, 522₂. . . respectively include a collected data storage area 222a for temporarily storing the transaction data obtained through the communicating units 53₁, 53₂, . . . , respectively, a transaction detail data storage area 222b for storing the transaction detail data, a calculation data storage area 222c for storing calculated data, and a household account data storage area 222d for storing the household account data, similarly to the information storing unit 222 in FIG. 2B.

A household account generating method using the household account generating system 1A in the second embodiment is the same as the household account generating method according to the first embodiment of the present invention other than that the household account generating apparatuses 5₁, 5₂, . . . perform both operations of the household account data generating apparatus 2 in FIG. 1 and the information processing apparatuses 4₁, 4₁, . . . in FIG. 1 according to the first embodiment of the present invention, and the explanation thereof will be omitted.

Third Embodiment

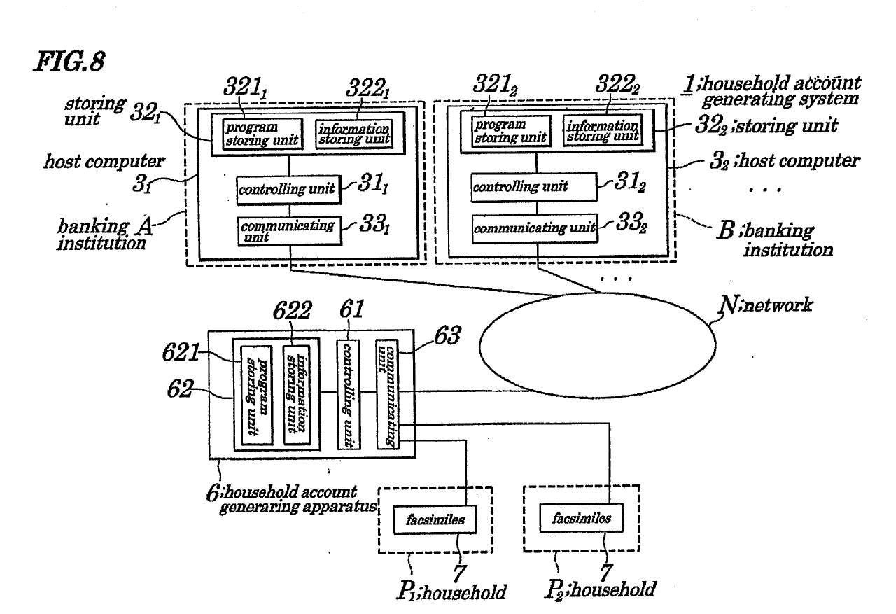

FIG. 8 is a block diagram showing a configuration of a household account generating system 1B according to a third embodiment of the present invention.

As shown in FIG. 8, a different point from the first embodiment is that facsimiles 7₁, 7₂, . . . , which are provided in households P₁, P₂, . . . , respectively, receive household account data generated by a household account generating apparatus 6 by facsimile communication.

The configurations of the third embodiment other than the point described above are the same as the configuration of the first embodiment and the explanation thereof will be omitted.

As shown in FIG. 8, for example, the household account generating system 1B (corresponding to a system for generating a household account in claims) includes the household account generating apparatus 6 for automatically generating a household account book, host computers 3₁, 3₂, . . . , which are provided in banking institutions A, B. . . . , for providing the transaction data including account information, debit card transaction information or a like to the household account generating apparatus 6 through a network N such as the Internet in response to a request, and the facsimiles 7₁, 7₂, . . . , which are provided, for example, in the household P₁, P₂, . . . , for receiving the household account book from the household account generating apparatus 6 through a communication line.

The household account generating apparatus 6 includes a controlling unit 61 for controlling each unit in accordance with a predetermined control program, a storing unit 62 for storing various programs and data, a communicating unit 63 for communicating with the host computers 3₁, 3₂, . . . in accordance with a predetermined protocol and communicating with the facsimiles 7₁, 7₂, . . .

The controlling unit 61 executes the household account generating program 2211 or the like stored in program storing unit 521₁ (that will be described later), control each unit of the household account generating apparatuses 6 by using various registers and flags provided in the storing unit 62 and then generating the household account book.

The storing unit 62 includes a ROM (Read Only Memory) (not shown), a RAM (Random Access Memory) (not shown), and a hard disk storage device (not shown). Also, the storing unit 62 may include a semiconductor memory such as an IC memory card or a like, a floppy disk storage device, or a magneto-optical disc storage device. In addition, the storing unit 62 includes the program storing unit 621 for storing various process programs including a household account generating program 2211 conducted by the controlling unit 61, and information storing unit 622 for storing received household account data or processed household account data. Also, the storing unit 62 include various registers and flags used by the controlling unit 61 executing the programs.

The household account generating program 2211 stored in the program storing unit 621 includes a data collecting process program 221a for periodically collecting transaction data such as general account information, debit card transaction information or a like from the host computers 3₁, 3₂, . . . through a communicating unit 63 and then temporarily storing the transaction data; a data accumulating process program 221b for generating transaction detail data and then storing the transaction detail data; a calculating process program 221c for calculating the transaction detail data and then storing the calculation data; and an editing process program 221d for conducting an editing process of the calculation data to adjust in a predetermined form, further, for example, displaying a graph, creating household account data for a specific period specified by the user and then storing the household account data.

Also, the information storing unit 622 includes a collected data storage area 222a for temporarily storing the transaction data obtained through the communicating unit 63, a transaction detail data storage area 222b for storing the transaction detail data, a calculation data storage area 222c for storing calculated data, and a household account data storage area 222d for storing the household account data, similarly to the information storing unit 222 in FIG. 2B.

A household account generating method using the household account generating system 1B in the third embodiment is the same as the household account generating method according to the first embodiment of the present invention other than that the household accounts generating apparatus 6 performs both operations of the household account data generating apparatus 2 in FIG. 1 and the information processing apparatuses 4₁, 4₁, . . . in FIG. 1 according to the first embodiment of the present invention, and the explanation thereof will be omitted.

As described above, in the third embodiment, it is possible to obtain similar effects to the first embodiment.

It is apparent that the present invention is not limited to the above embodiments but may be changed and modified without departing from the scope and spirit of the invention.

For example, in the embodiments described above, the information processing apparatus 4₁, 4₂, . . . , which are provided in the households P₁, P₂, . . . , respectively, receives the transaction data from the household account data generating apparatus 2. Alternatively, an ATM (Automated Teller Machine) or a CD (Cash Dispenser) can be configured as a receiving terminal in that a household account data receiving function, a household account generating function and a household account output function are provided, and may output or display the household account book. Also, for example, a special terminal for outputting or displaying the household account book may be provided in any of the banking institutions A, B, . . .

Alternatively, as a receiving terminal, a cellular phone capable of communicating data can be used. Thus, for example, the cellular phone may be used to confirm a balance of each account to determine to the user in his/her decision process whether to purchase an additional product during shopping.

Moreover, the network N is not limited to the Internet but can include a dedicated communication line that can be any kind of a communication such as a wireless or cable communication.

Furthermore, in the embodiments described above, the transaction data is automatically sent to the information processing apparatuses 4₁, 4₂, . . . from the household account data generating apparatus 2. Alternatively, in response to a request of the information processing apparatus 4₁, 4₂, . . . , only necessary information (for example, income information, balance information or a like for one day) can be sent to the information processing apparatuses 4₁, 4₂, . . . from the household account data generating apparatus 2.

What is claimed is:

1. A system for generating accounting data, comprising:
an information collecting means for collecting expense information including purchasing instrument information obtained by a settlement process of a business transaction using a purchasing instrument capable for payment; and
a data generating means for generating accounting data of a user of said purchasing instrument or a accounting summary of a household of said user.

2. The system for generating accounting data according to claim 1, wherein: said purchasing instrument is a debit card issued by a banking institution.

3. The system for generating accounting data according to claim 1, wherein:
said expense information includes account information of a banking institution where said user or said household has an account; and
said data generating means conducts a calculating process and an editing process to said expense information and generates said accounting data.

4. The system for generating accounting data according to claim 1, further comprising a sending means for sending said accounting data to a predetermined receiving terminal through a communication line.

5. The system for generating accounting data according to claim 1, wherein said information collecting means is provided in said banking institution and receives said expense information from a computer accumulating said expense information through a communication line.

6. The system for generating accounting data according to claim 1, wherein said information collecting means collects income information and said data generating means generates said accounting data of said user or said household account summary of said household of said user based on said expense information and said income information.

7. The system for generating accounting data according to claim 4, further comprising a household account book data generating means for generating a household account book data based on said accounting data generated by said data generating means wherein said sending means sends said household account book data to a predetermined facsimile through said communication line.

8. The system for generating accounting data according to claim 4, wherein said information collecting means is provided in said banking institution and receives said expense information from a computer accumulating said expense information through a communication line.

9. The system for generating accounting data according to claim 4, wherein said receiving terminal generates a accounting book data based on said accounting data received from said communication line.

10. The system for generating accounting data according to claim 4, wherein said communication line includes Internet.

11. The system for generating accounting data according to claim 4, wherein said receiving terminal is an information processing apparatus provided in said household of said user.

12. The system for generating accounting data according to claim 4, wherein said receiving terminal is an output terminal provided in said banking institution or an automated transaction apparatus including a receiving function for receiving said accounting data.

13. A method for generating accounting data, comprising steps of:
(a) step for collecting expense information including purchasing instrument information obtained by a settlement process of a business transaction using a purchasing instrument capable for payment; and
(b) step for generating accounting data of a user of the purchasing instrument or a accounting summary of a household of said user.

14. The method for generating accounting data according to claim 13, wherein:
said expense information includes account information of a banking institution where said user or said household has an account; and
said step (b) conducts a calculating process and an editing process to said expense information and generates said accounting data.

15. A computer-readable recording medium recorded with a program for causing a computer to generate accounting data, comprising codes of:
(a) code for collecting expense information including purchasing instrument information obtained by a settlement process of a business transaction using a purchasing instrument capable for payment; and
(b) code for generating accounting data of a user of said purchasing instrument or a accounting summary of a household of said user.

16. The computer-readable recording medium according to claim 15, wherein:
said expense information includes account information of a banking institution where said user or said household has an account; and
said code (b) conducts a calculating process and an editing process to said expense information and generates said accounting data.
